(19) United States
(12) Patent Application Publication
(10) Pub. No.: US 2025/0376179 A1
(43) Pub. Date: Dec. 11, 2025

(54) APPARATUS AND METHOD FOR ASSISTING DRIVING OF HOST VEHICLE

(71) Applicant: HL MANDO CORPORATION, Pyeongtaek-si (KR)

(72) Inventor: Youngeun CHO, Pyeongtaek-si (KR)

(73) Assignee: HL MANDO CORPORATION, Pyeongtaek-si (KR)

(21) Appl. No.: 19/215,752

(22) Filed: May 22, 2025

(30) Foreign Application Priority Data
Jun. 11, 2024 (KR) 10-2024-0075433

(51) Int. Cl. B60W 50/029; B60W 10/184; B60W 10/22

(52) U.S. Cl. CPC B60W 50/029; B60W 10/184; B60W 10/22; B60W 2510/205; B60W 2710/18; B60W 2710/226

(57) ABSTRACT

The present disclosure provides a driving assistance apparatus of a host vehicle including a sensor configured to detect a steering angle or a steering angular velocity of a steering wheel of the host vehicle and a controller connected to the sensor, and the controller is configured to steer the host vehicle with a biased brake torque when a steering system fails and control a damping force of a damper provided on each wheel of the host vehicle when the host vehicle starts turning.

### CROSS-REFERENCE TO RELATED APPLICATION

This application claims priority to and the benefit from Korean Patent Application No. 10-2024-0075433, filed on Jun. 11, 2024, the disclosures of which are incorporated herein by reference in its entirety.

### BACKGROUND

The present disclosure relates to an apparatus and method for assisting driving of a host vehicle.

A steering assistance system of a vehicle is a system that assists a driver in changing a direction of travel of the vehicle according to his or her will and is a system that assists the driver in more easily driving the vehicle by generating a steering assistance force in a direction of travel desired by the driver.

The steering assistance systems are implemented as hydraulic power steering apparatuses (HPS), electric power steering apparatuses (EPS), and the like.

In recent years, a steer-by-wire (SBW) steering system in which mechanical connecting devices between a steering wheel and wheels, such as steering columns are eliminated and instead the steering wheel and the wheels are connected through wires and the steering of the vehicle is accomplished by driving a motor, has been developed and applied.

However, since the steer-by-wire steering system has no mechanical connection between the steering wheel and the wheels, when there is a problem with communication and a steering signal is not transmitted, the steering performance may be completely lost, which may cause a major accident.

Accordingly, in case a specific configuration included in the system fails, in the recent steering assistance system, a redundancy system in which a configuration identical to the specific configuration is added has been applied, fail safety has been implemented based on the redundancy system, and technological development to more stably implement fail safety is increasingly being made.

However, there is a problem of increasing costs when an additional redundancy system is installed in order to implement redundancy.

### SUMMARY

The present disclosure is directed to implementing redundancy by steering a host vehicle using a biased brake force of a braking system when a steering system fails.

In addition, the present disclosure is directed to improving an inner grip in a turning direction by minimizing the roll of a host vehicle when the host vehicle is turning with a biased brake force, thereby improving the turning performance of the host vehicle.

In addition, the present disclosure is directed to improving the turning performance of a host vehicle by increasing the moment in a turning direction of the host vehicle through damping force distribution of dampers.

In addition, the present disclosure is directed to further improving turning stability by adjusting a damping force of a damper by stages according to a turning degree of a host vehicle.

Problems to be solved by the present disclosure are not limited to those mentioned above, and other problems not mentioned will be clearly understood by those of ordinary skill in the art to which the present disclosure belongs from the following description.

According to an aspect of the present disclosure, there is provided an apparatus for assisting driving of a host vehicle, including a sensor configured to detect a steering angle or a steering angular velocity of a steering wheel of the host vehicle and a controller connected to the sensor, in which the controller is configured to steer the host vehicle with a biased brake torque when a steering system fails and control a damping force of a damper provided on each wheel of the host vehicle when the host vehicle starts turning.

The controller may calculate the biased brake torque based on the steering angle and transmit a signal including information about the biased brake torque to a braking system of the host vehicle.

The braking system may steer the host vehicle based on the biased brake torque.

The controller may determine whether the host vehicle starts turning based on the steering angle or the steering angular velocity, and determine a damping ratio of the damper.

The controller may determine that the host vehicle starts turning when the steering angle is equal to or greater than a reference angle or the steering angular velocity is equal to or greater than a reference angular velocity and increase a damping ratio of the dampers.

The controller may provide a signal including information about the damping ratio of the damper to a suspension system of the host vehicle.

The suspension system may control the damping force of the damper based on the damping ratio of the damper.

The controller may increase the damping ratio of the dampers provided on wheels to which the biased brake torque is applied.

The controller may be configured to a adjust the damping force of the damper provided on a front wheel, to which the biased brake torque is applied according to a first stage, and adjust the damping force of the damper provided on a rear wheel to which the biased brake torque is applied according to a second stage, wherein the damping force according to the first stage is larger than the damping force according to the second stage.

The controller may control the damping force of the damper according to a plurality of the first stages or a plurality of the second stages.

The controller may calculate a turning angle of the host vehicle based on the steering angle or the steering angular velocity.

The controller may determine the plurality of the first stages or the plurality of the second stages according to the turning angle of the host vehicle.

According to another aspect of the present disclosure, there is provided a method of assisting driving of a host vehicle, including detecting a steering angle or a steering angular velocity of a steering wheel of the host vehicle, steering the host vehicle with a biased brake torque when a steering system fails, and controlling a damping force of a damper provided on each wheel of the host vehicle when the host vehicle starts turning.

The steering of the host vehicle with the biased brake torque may include calculating the biased brake torque based on the steering angle, transmitting a signal including information about the biased brake torque to a braking system of the host vehicle, and steering, by the braking system, the host vehicle based on the biased brake torque.

The controlling of the damping may include determining whether the host vehicle starts turning based on the steering angle or the steering angular velocity and determining a damping ratio of the dampers.

The controlling of the damping force may include determining that the host vehicle starts turning when the steering angle is equal to or greater than a reference angle or the steering angular velocity is equal to or greater than a reference angular velocity and increasing a damping ratio of the damper, providing a signal including information about the damping ratio of the damper to a suspension system of the host vehicle, and controlling, by the suspension system, the damping force of the damper based on the damping ratio of the damper.

The increasing of the damping ratio may include increasing the damping ratio of the damper provided on a wheel to which the biased brake torque is applied.

The controlling of the damping force may include adjusting the damping force of the damper provided on a front wheel, to which the biased brake torque is applied according to a first stage, and adjusting the damping force of the damper provided on a rear wheel, to which the biased brake torque is applied according to a second stage, wherein the damping force according to the first stage is larger than the damping force according to the second stage.

The controlling of the damping force may include controlling the damping force of the damper according to a plurality of the first stages or a plurality of the second stages.

The controlling of the damping force may include calculating a turning angle of the host vehicle based on the steering angle or the steering angular velocity and determining the plurality of the first stages or the plurality of the second stages according to the turning angle of the host vehicle.

### BRIEF DESCRIPTION OF THE DRAWINGS

The above and other objects, features, and advantages of the present disclosure will become more apparent to those of ordinary skill in the art by describing exemplary embodiments thereof in detail with reference to the accompanying drawings, in which:

FIG. 1 is a view schematically illustrating a steering system according to an embodiment of the present disclosure;

FIG. 2 is a block diagram of a driver assistance apparatus of a host vehicle according to an embodiment of the present disclosure;

FIG. 3 is a view for describing the operation of the driver assistance apparatus of a host vehicle according to the embodiment of the present disclosure;

FIGS. 4 and 5 are views for describing a principle of improving turning performance by adjusting a damping force of a damper in a driving assistance apparatus of a host vehicle according to an embodiment of the present disclosure; and

FIG. 6 is a flowchart of a method of assisting a driver of a host vehicle according to an embodiment of the present disclosure.

### DETAILED DESCRIPTION

Hereinafter, embodiments of the present disclosure will be described in detail so that those skilled in the art to which the present disclosure pertains can easily carry out the embodiments. The present disclosure may be implemented in many different forms and is not limited to the embodiments described herein. In order to clearly describe the present disclosure, portions not related to the description are omitted from the accompanying drawings, and the same or similar components are denoted by the same reference numerals throughout the specification.

The words and terms used in the specification and the claims are not limitedly construed as their ordinary or dictionary meanings, and should be construed as meaning and concept consistent with the technical spirit of the present disclosure in accordance with the principle that the inventors can define terms and concepts in order to best describe their disclosure.

In the specification, it should be understood that the terms such as “comprise” or “have”, are intended to specify the presence of features, numbers, steps, operations, components, parts, or combinations thereof described in the specification and do not preclude the possibility of the presence or addition of one or more other features, numbers, steps, operations, components, parts, or combinations thereof.

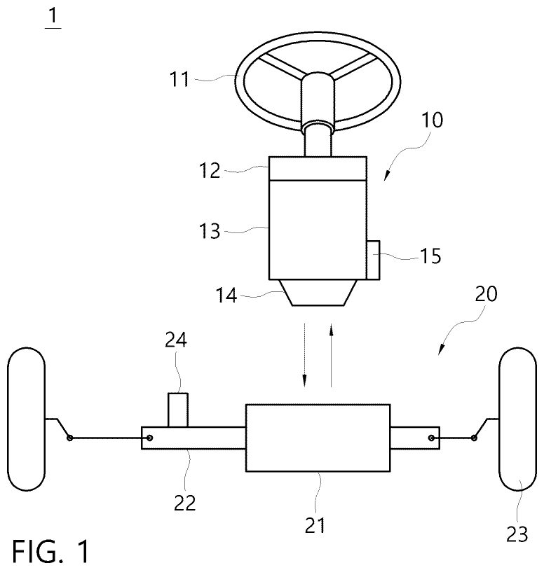

FIG. 1 is a view schematically illustrating a steering system according to an embodiment of the present disclosure.

Referring to FIG. 1, a steering system 1 according to an embodiment of the present disclosure may assist steering power so that a driver may easily steer a host vehicle.

Depending on a driving method, the steering system 1 may include a hydraulic type system (hydraulic power steering (HPS)) that generates hydraulic pressure by rotating a pump to provide steering assistance power, an electric type system (electronic power steering (EPS)) that drives a motor to provide steering assistance power, or the like.

Hereinafter, for convenience, the steering system 1 according to the embodiment of the present disclosure will be described based on the electric type steering system, but is not limited thereto.

The steering system 1 according to the embodiment of the present disclosure may be divided into a mechanical steering system and a steer-by-wire (SbW) steering system depending on whether an input actuator 10 and a steering actuator 20 are connected by a mechanical connecting member.

The mechanical steering system is a steering system in which the input actuator 10 and the steering actuator 20 are mechanically connected through a mechanical connecting member. According to the mechanical steering system, rotational power (torque) generated by a driver turning a steering wheel 11 is transmitted to the steering actuator 20 through a mechanical power transmission device or a mechanical connecting member (e.g., a linkage, a steering shaft, and a universal joint), so that a wheel 23 of the host vehicle may be steered.

The steer-by-wire steering system is a steering system in which the input actuator 10 and the steering actuator 20 are electrically connected through wires, cables, or the like instead of the mechanical power transmission device. According to the steer-by-wire steering system, the input actuator 10 may detect a steering angle of the steering wheel 11, calculate a steering control value (e.g., a target rack stroke value) for the steering angle, and output an electric signal indicating the steering control value to the steering actuator 20 to drive the steering actuator 20.

The steering system 1 according to the embodiment of the present disclosure will be described as the steer-by-wire system for convenience, but is not limited thereto.

The steering system 1 according to the embodiment of the present disclosure may be configured to include the input actuator 10 and the steering actuator 20.

The steering system 1 according to the embodiment of the present disclosure may have the input actuator 10 and the steering actuator 20 connected by an electrical connecting member such as a wire and a cable.

The input actuator 10 is a steering input device that receives steering information intended by the driver (e.g., a steering angle of the steering wheel 11), generates a corresponding detection signal, and outputs the generated detection signal to the steering actuator 20. The input actuator 10 may be configured to include the steering wheel 11, a steering angle sensor 12, a reaction motor 13, a torque sensor 14, and a steering controller 15.

The steering angle sensor 12 may detect a steering angle generated by turning of the steering wheel 11. Specifically, when the driver turns the steering wheel 11, the steering angle sensor 12 may detect the steering angle, which is a rotation angle of the steering wheel 11, and output a detection signal representing the detected steering angle to the steering controller 15.

The reaction motor 13 may receive a command current from the steering controller 15 and apply a reaction force to the steering wheel 11. Specifically, the reaction motor 13 may receive a command current from the steering controller 15 and output a reaction torque by being driven at a rotation speed indicated by the command current.

The torque sensor 14 may detect the torque generated by the turning of the steering wheel 11. Specifically, when the driver of the host vehicle turns the steering wheel 11, the torque sensor 14 may detect the torque of the steering wheel 11 and output a detection signal representing the detected torque to the steering controller 15. Here, torque may refer to torque generated by a driver's operation of the steering wheel 11.

The steering controller 15 is a device that controls the steering of the host vehicle. Specifically, the steering controller 15 may receive detection signals indicating the steering angle and torque from the steering angle sensor 12 and the torque sensor 14, calculate a steering control value, and output a control signal representing the steering control value to the steering actuator 20.

In this case, the steering control value may refer to a target rack stroke value, a target rack position value, or the like.

The steering controller 15 may receive feedback about information on power actually output from the steering actuator 20, calculate a reaction force control value, and output a control signal indicating the reaction force control value to the input actuator 10, thereby providing a steering feeling to the driver.

The steering controller 15 may be implemented by an electronic control unit (ECU). In addition, the steering controller 15 may be included in the input actuator 10 or may be separated as a separate device and disposed in the host vehicle.

The steering actuator 20 is a steering output device that drives the host vehicle to be steered according to a driver's intention.

The steering actuator 20 may be configured to include a steering motor 21, a rack 22, a position sensor 24, and the wheel 23.

The steering motor 21 may move the rack 22 in an axial direction. Specifically, the steering motor 21 may be driven by receiving a control signal indicating a steering control value from the steering controller 15 and may cause the rack 22 to linearly move in the axial direction.

The rack 22 may perform linear movement by driving the steering motor 21, and the wheel 23 may be steered left or right through the linear movement of the rack 22.

The position sensor 24 may detect a position of the rack 22. Specifically, when the rack 22 performs linear movement so that the rack 22 is moved from a position corresponding to a neutral position of the steering wheel 11, the rack position sensor 24 may detect an actual position of the rack 22 and output a detection signal indicating a position detection value of the rack 22 to the steering controller 15.

In this case, the position sensor 24 may detect an actual moving speed of the rack 22. That is, the position sensor 24 may detect the position of the rack 22, calculate the moving speed of the rack 22 by differentiating the detected position of the rack 22 with respect to time, and output a detection signal indicating the moving speed value of the rack 22 to the steering controller 15.

The steering actuator 20 according to the embodiment of the present disclosure may further include an electronic control unit (ECU). The steering actuator 20 may receive a control signal from the steering controller 15, check the validity of the control signal, and output the control signal to the steering motor 21.

The steering system 1 according to the embodiment of the present disclosure may further include a steering column, a pinion gear, a vehicle speed sensor for detecting a traveling speed of a vehicle, a steering angle sensor for detecting a steering angle of the wheel 23, a yaw rate sensor for detecting a heading angle of the vehicle, a clutch capable of separating or combining a steering input unit and a steering output unit, and the like.

Meanwhile, unlike the mechanical steering system, in the steer-by-wire steering system, since the input actuator 10 and the steering actuator 20 are electrically connected, when a communication problem occurs and the steering signal is not transmitted to the steering actuator 20, the steering performance may be completely lost, which may cause a major accident.

In order to solve the problem, the present disclosure provides a driver assistance apparatus of a host vehicle that steers the host vehicle using a biased brake force when the steering system 1 fails.

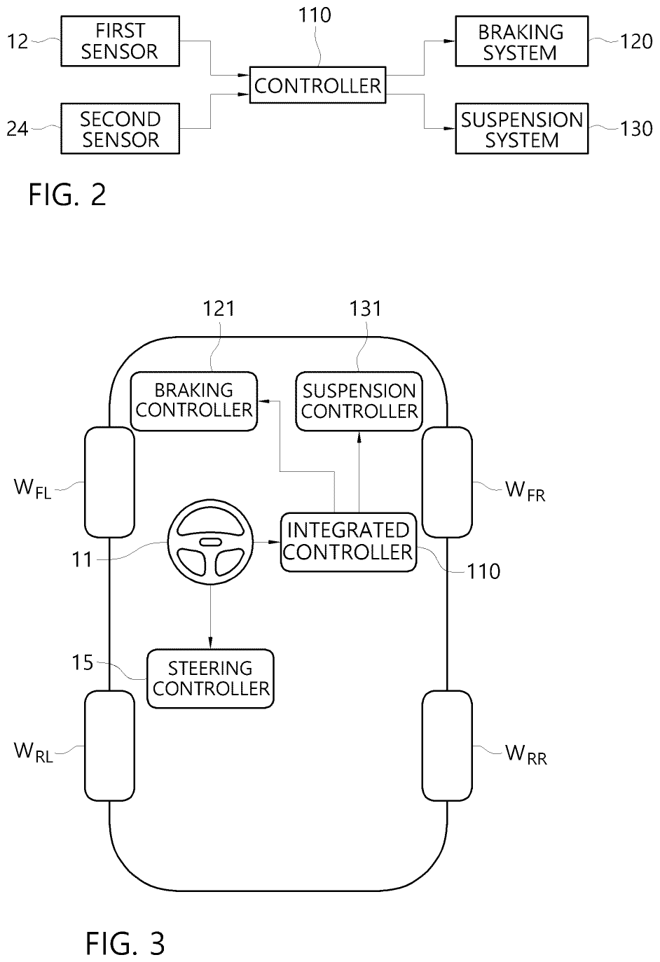

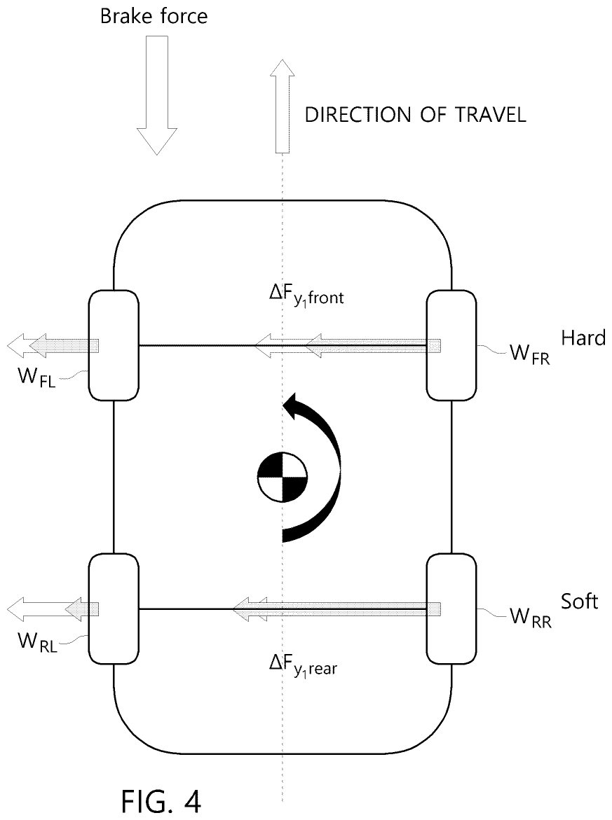

FIG. 2 is a block diagram of a driver assistance apparatus of a host vehicle according to an embodiment of the present disclosure, and FIG. 3 is a view for describing the operation of the driver assistance apparatus of a host vehicle according to the embodiment of the present disclosure.

Referring to FIG. 2, the driver assistance apparatus of a host vehicle according to an embodiment of the present disclosure may be configured to include a first sensor 12, a second sensor 24, a controller 110, a braking system 120, and a suspension system 130.

The first sensor 12 may detect a first steering angle or a steering angular velocity of the steering wheel 11 of the host vehicle, and the second sensor 24 may detect a second steering angle of a front wheel of the host vehicle or the position of the rack 22 of the steering system 1.

The controller 110 may be communicatively connected to the first sensor 12 and the second sensor 24.

The controller 110 may determine whether the steering system 1 of the host vehicle fails based on the first steering angle of the steering wheel 11 and the second steering angle of the front wheel. In addition, the controller 110 may determine whether the steering system 1 of the host vehicle fails based on the first steering angle of the steering wheel 11 and the position of the rack 22 of the steering system 1.

For example, the controller 110 may determine that the steering system 1 fails when the second steering angle of the front wheel or the position of the rack 22 remains the same even though the driver of the host vehicle turns the steering wheel 11 so that the first steering angle is changed.

The controller 110 may steer the host vehicle with a biased brake torque based on the determination that the steering system 1 fails.

Referring to FIG. 3, the driver assistance apparatus of a host vehicle according to the embodiment of the present disclosure may be configured to include a steering controller 15 that controls the steering system 1, a braking controller 121 that controls the braking system 120, a suspension controller 131 that controls the suspension system 130, and an integrated controller 110 that controls the steering controller 15, the braking controller 121, and the suspension controller 131.

The steering controller 15 steers the host vehicle by moving the rack 22 according to the first steering angle of the steering wheel 11. Here, the steering controller 15 may transmit steering failure information to the integrated controller 110 when the steering system 1 fails.

In contrast, the integrated controller 110 may determine whether the steering system 1 fails by receiving information on the first steering angle from the first sensor 12 and information on the second steering angle of the front wheel or the position of the rack 22 from the second sensor 24.

When the integrated controller 110 receives steering failure information from the steering controller 15 or determines that the steering system 1 fails, the integrated controller 110 may provide an audible or visual alarm to limit the driver's will to accelerate and guide the driver to quickly evacuate the host vehicle to prevent an accident due to the failure of the steering system 1.

The integrated controller 110 may calculate a target moment of the host vehicle based on the first steering angle of the steering wheel 11 when the steering system 1 fails, calculate the biased brake torque based on the target moment, and provide the biased brake torque to the braking controller 121.

Accordingly, the braking controller 121 steers the host vehicle by controlling a braking device according to the biased brake torque.

For example, when the steering wheel 11 is turned in a first direction by the first steering angle, the braking controller 121 may steer the host vehicle in the first direction by applying a brake force corresponding to the first steering angle only to the wheel 23 positioned in the first direction.

Accordingly, the driver assistance apparatus of the host vehicle according to the embodiment of the present disclosure may implement redundancy and prevent accidents by steering the host vehicle using the biased brake force of the braking system 120 when the steering system 1 fails, and since there is no need to additionally provide a redundancy actuator to implement redundancy, there is an advantage in terms of cost.

The suspension controller 131 that controls the suspension system 130 adjusts the damping force of the damper provided on each of the wheels of the host vehicle to alleviate shock and vibration received by the host vehicle from a road surface so that the shock and vibration are prevented from being transmitted to a body of the host vehicle.

Here, when the damping force of the damper is adjusted to be soft, the ride comfort increases but driving safety decreases, and when the damping force is adjusted to be hard, the ride comfort decreases but driving safety increases.

Meanwhile, when the host vehicle is steered by applying the biased brake force, vehicle moment is generated, and thus rotational movement occurs. In this case, a roll occurs in the host vehicle due to the rotational movement, and when the roll occurs, the grip of the wheels to which the biased brake force is applied is reduced. Accordingly, there is a problem that the turning performance of the host vehicle is reduced.

In order to solve the problem, the present disclosure provides the driver assistance apparatus of a host vehicle that compensates for the turning performance reduced due to the biased brake force when the host vehicle is turning using the biased brake force.

To this end, the integrated controller 110 may compensate for the turning performance of the host vehicle reduced due to the biased brake torque by controlling the damping forces of the dampers provided on the wheels of the host vehicle.

Specifically, the integrated controller 110 may calculate the biased brake torque based on the first steering angle of the steering wheel 11 and provide the biased brake torque to the braking system 120. Accordingly, the braking controller 121 of the braking system 120 may steer the host vehicle by bias-braking the host vehicle based on the biased brake torque.

Here, the integrated controller 110 may determine whether the host vehicle starts turning based on the first steering angle or the steering angular velocity and determine the damping ratio of the damper.

Specifically, the integrated controller 110 may determine that the host vehicle starts turning based on the first steering angle being equal to or greater than a reference angle or the steering angular velocity being equal to or greater than a reference angular velocity and increase the damping ratio of the damper.

In addition, the integrated controller 110 may provide the damping ratio of the damper to the suspension system 130, and the suspension system 130 may control the damping force of the damper based on the damping ratio of the damper.

The integrated controller 110 may increase the damping ratio of the damper provided on the wheel to which the biased brake torque is applied, thereby increasing the damping force of the damper. Accordingly, the inner grip in a turning direction may be improved by minimizing the roll of the host vehicle due to the increased damping force, thereby improving the turning performance of the host vehicle.

In addition, the integrated controller 110 may adjust the damping force of the damper provided on a front wheel to which the biased brake torque is applied to be hard and adjust the damping force of the damper provided on a rear wheel to which the biased brake torque is applied to be soft.

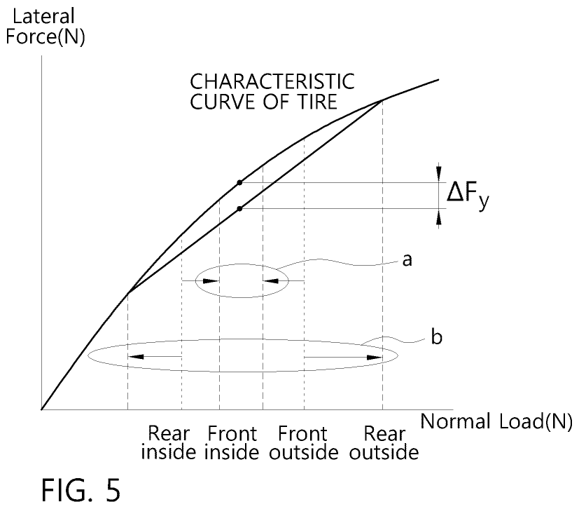

FIGS. 4 and 5 are views for describing a principle of improving turning performance by adjusting a damping force of a damper in a driving assistance apparatus of a host vehicle according to an embodiment of the present disclosure.

Referring to FIG. 4, while the host vehicle is turning with a biased brake force in a state where the steering system 1 of the host vehicle fails, a damping force of a damper provided on a left front wheel WFL to which the biased brake force is applied is adjusted to be hard, and a damping force of a damper provided on a left rear wheel WRL to which the biased brake force is applied is adjusted to be soft.

In this case, referring to FIG. 5, compared to a case where the damping force of the damper is not adjusted, a lateral force difference AFylfront between the left front wheel WFL and a right front wheel WFR decreases (a), and a lateral force difference AFylrear between the left rear wheel WRL and a right front wheel WRR increases (b). As a yaw moment is generated in the vehicle due to the difference in the lateral force, the turning performance of the host vehicle may be further improved compared to the case where the damping force of the damper is not adjusted.

In this way, the driving assistance apparatus of a host vehicle according to the embodiment of the present disclosure may increase the moment in the turning direction of the host vehicle by distributing the damping forces of the dampers provided on the left front wheel WFL and the left rear wheel WRL to which the biased brake force is applied to hard and soft, respectively, while the host vehicle is turning with the biased brake force in a state where the steering system 1 of the host vehicle fails, thereby improving the turning performance of the host vehicle.

Meanwhile, when the damping forces of the dampers provided on the left front wheel WFL and the left rear wheel WRL are adjusted by being uniformly distributed to hard and soft, respectively, even though the turning degree of the host vehicle is low, a problem of lowering turning stability may occur.

In order to solve the problem, the driving assistance apparatus of a host vehicle according to the embodiment of the present disclosure controls a damping force of a damper by stages while the host vehicle is turning with the biased brake force in a state where the steering system 1 of the host vehicle fails.

The integrated controller 110 may set a plurality of hard stages, each indicating the degree of damping force when adjusting the damping force of the damper to be hard, and may set a plurality of soft stages, each indicating the degree of damping force when adjusting the damping force of the damper to be soft. Here, the damping force of the damper may be set to increase as the hard stage number is lower, and the damping force of the damper may be set to decrease as the soft stage number is greater.

The plurality of hard stages and the plurality of soft stages may be stored in memory.

The integrated controller 110 may control the damping force of the damper according to the plurality of hard stages or the plurality of soft stages.

Specifically, the integrated controller 110 may calculate the turning angle of the host vehicle based on the steering angle or the steering angular velocity and determine a plurality of hard stages or a plurality of soft stages according to the turning angle of the host vehicle.

For example, referring to FIG. 4, the hard stages are set to stages 1 to 4, and the soft stages are set to stages 1 to 4, and when the turning angle of the host vehicle is very large, the damping force of the damper provided on the left front wheel WFL to which the biased brake force is applied may be adjusted to the hard stage 1, and the damping force of the damper provided on the left rear wheel WRL to which the biased brake force is applied may be adjusted to the soft stage 4.

In this way, the driving assistance apparatus of a host vehicle according to the embodiment of the present disclosure may further improve turning stability by adjusting the damping force of the damper by stages according to the turning degree of the host vehicle.

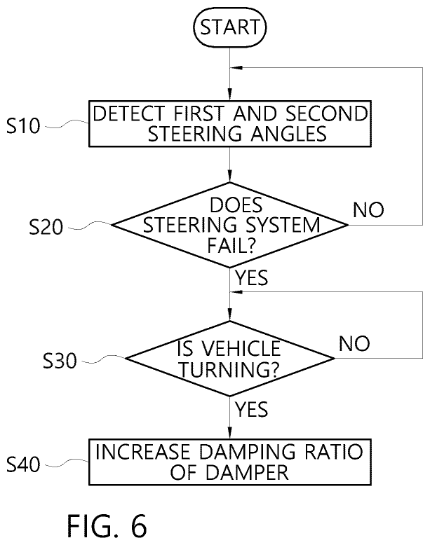

FIG. 6 is a flowchart of a method of assisting a driver of a host vehicle according to an embodiment of the present disclosure.

Hereinafter, with reference to FIG. 6, the method of assisting a driver of a host vehicle according to the embodiment of the present disclosure will be described, but some of the same contents as those described above will be omitted.

Referring to FIG. 6, the method of assisting a driver of a host vehicle according to the embodiment of the present disclosure first detects a first steering angle or a steering angular velocity of the steering wheel 11 of the host vehicle and then detects a second steering angle of the front wheel of the host vehicle or the position of the rack 22 of the steering system 1 (S10).

Next, based on the first steering angle of the steering wheel 11 and the second steering angle of the front wheel, a determination as to whether the steering system 1 of the host vehicle fails is made (S20). At this time, the determination as to whether the steering system 1 of the host vehicle fails may also be made based on the first steering angle of the steering wheel 11 and the position of the rack 22 of the steering system 1.

For example, it may be determined that the steering system 1 fails when the second steering angle of the front wheel or the position of the rack 22 remains the same even though a driver of the host vehicle turns the steering wheel 11 so that the first steering angle is changed.

Next, when it is determined that the steering system 1 fails, the host vehicle is steered with a biased brake torque.

Specifically, when the steering system 1 fails, a target moment of the host vehicle may be calculated based on the first steering angle of the steering wheel 11, and the biased brake torque may be calculated based on the target moment and provided to the braking controller 121.

Accordingly, the braking controller 121 steers the host vehicle by controlling the braking device according to the biased brake torque.

Accordingly, the method of assisting a driver of a host vehicle according to the embodiment of the present disclosure may implement redundancy and prevent accidents by steering the host vehicle using the biased brake force of the braking system 120 when the steering system 1 fails, and since there is no need to additionally provide a redundancy actuator to implement redundancy, there is an advantage in terms of cost.

Next, a determination as to whether the host vehicle starts turning is made based on the first steering angle or the steering angular velocity (S30). In this case, specifically, the controller 110 may determine that the host vehicle starts turning when the first steering angle is equal to or greater than a reference angle or the steering angular velocity is equal to or greater than a reference angular velocity.

Next, when it is determined that the host vehicle starts turning, the damping ratio of the damper is increased (S40).

In this case, the damping ratio of the damper is provided to the suspension system 130, and the suspension system 130 increases the damping force of the damper based on the damping ratio of the damper.

Accordingly, the inner grip in the turning direction may be improved by minimizing the roll of the host vehicle due to the increased damping force, thereby improving the turning performance of the host vehicle.

In addition, the damping force of the damper provided on a front wheel to which the biased brake torque is applied may be adjusted to be hard, and the damping force of the damper provided on a rear wheel to which the biased brake torque is applied may be adjusted to be soft.

In this way, the method of assisting driving of a host vehicle according to the embodiment of the present disclosure may increase the moment in the turning direction of the host vehicle by distributing the damping forces of the dampers provided on the left front wheel WFL and the left rear wheel WRL to which the biased brake force is applied to hard and soft, respectively, while the host vehicle is turning with the biased brake force in a state where the steering system 1 of the host vehicle fails, thereby improving the turning performance of the host vehicle.

In addition, a plurality of hard stages, each indicating the degree of damping force may be set when adjusting the damping force of the damper to be hard, and a plurality of soft stages, each indicating the degree of damping force may be set when adjusting the damping force of the damper to be soft. Here, the damping force of the damper may be set to increase as the hard stage number is lower, and the damping force of the damper may be set to decrease as the soft stage number is greater.

In addition, the turning angle of the host vehicle may be calculated based on the first steering angle or the steering angular velocity of the steering wheel 11, and the plurality of hard stages or the plurality of soft stages may be determined according to the turning angle of the host vehicle.

In this case, the damping force of the damper may be controlled according to the plurality of determined hard stages or the plurality of determined soft stages.

In this way, the method of assisting driving of a host vehicle according to the embodiment of the present disclosure may further improve turning stability by adjusting the damping force of the damper by stages according to the turning degree of the host vehicle.

According to the present disclosure, by steering a host vehicle using a biased brake force of a braking system when a steering system fails, redundancy can be implemented and accidents can be prevented, and since there is no need to additionally provide a redundancy actuator to implement redundancy, there is an advantage in terms of cost.

In addition, according to the present disclosure, an inner grip in a turning direction can be improved by increasing a damping force of a damper provided on a wheel to which a biased brake torque is applied and minimizing the roll of a host vehicle due to the increased damping force, thereby improving the turning performance of the host vehicle.

In addition, according to the present disclosure, the moment in a turning direction of a host vehicle can be increased by distributing damping forces of dampers provided on wheels to which a biased brake force is applied to hard and soft, respectively, while the host vehicle is turning with the biased brake force in a state where a steering system of the host vehicle fails, thereby improving the turning performance of the host vehicle.

In addition, according to the present disclosure, a damping force of a damper can be adjusted by stages according to a turning degree of a host vehicle, thereby further improving turning stability.

Effects of the present disclosure are not limited to the above-described effects but should be understood to include all effects that can be deduced from features of disclosures described in the detailed description or the claims of the present disclosure.

It should be understood that the effects of the present disclosure are not limited to the above-described effects, and include all effects inferable from a configuration of the disclosure described in detailed descriptions or claims of the present disclosure.

Although embodiments of the present disclosure have been described, the spirit of the present disclosure is not limited by the embodiments presented in the specification. Those skilled in the art who understand the spirit of the present disclosure will be able to easily suggest other embodiments by adding, changing, deleting, or adding components within the scope of the same spirit, but this will also be included within the scope of the spirit of the present disclosure.

What is claimed is:

1. An apparatus for assisting driving of a host vehicle, the apparatus comprising:
a sensor configured to detect a steering angle or a steering angular velocity of a steering wheel of the host vehicle; and
a controller connected to the sensor,
the controller is configured to:
steer the host vehicle with a biased brake torque when a steering system fails; and
control a damping force of a damper provided on each wheel of the host vehicle when the host vehicle starts turning.

2. The apparatus of claim 1, wherein the controller is further configured to: calcaulate the biased brake torque based on the steering angle; and transmit a signal including information about the biased brake torque to a braking system of the host vehicle.

3. The apparatus of claim 2, wherein the braking system is configured to: steer the host vehicle based on the biased brake torque.

4. The apparatus of claim 1, wherein the controller is further configured to: determine whether the host vehicle starts turning based on the steering angle or the steering angular velocity; and determine a damping ratio of the damper.

5. The apparatus of claim 1, wherein the controller is further configured to: determine that the host vehicle starts turning when the steering angle is equal to or greater than a reference angle or the steering angular velocity is equal to or greater than a reference angular velocity; and increase a damping ratio of the damper.

6. The apparatus of claim 5, wherein the controller is further configured to: transmit a signal including information about the damping ratio of the damper to a suspension system of the host vehicle.

7. The apparatus of claim 6, wherein the suspension system is configured to: control the damping force of the damper based on the damping ratio of the damper.

8. The apparatus of claim 5, wherein the controller is further configured to: increase the damping ratio of the damper provided on a wheel, to which the biased brake torque is applied.

9. The apparatus of claim 5, wherein the controller is further configured to:
adjust the damping force of the damper provided on a front wheel, to which the biased brake torque is applied according to a first stage; and
adjust the damping force of the damper provided on a rear wheel to which the biased brake torque is applied according to a second stage;
wherein the damping force according to the first stage is larger than the damping force according to the second stage.

10. The apparatus of claim 9, wherein the controller is further configured to: control the damping force of the damper according to a plurality of the first stages or a plurality of the second stages.

11. The apparatus of claim 10, wherein the controller is further configured to: calculate a turning angle of the host vehicle based on the steering angle or the steering angular velocity.

12. The apparatus of claim 11, wherein the controller is further configured to: determine the plurality of the first stages or the plurality of the second stages according to the turning angle of the host vehicle.

13. A method of assisting driving of a host vehicle, the method comprising:
detecting a steering angle or a steering angular velocity of a steering wheel of the host vehicle;
steering the host vehicle with a biased brake torque when a steering system fails; and
controlling a damping force of a damper provided on each wheel of the host vehicle when the host vehicle starts turning.

14. The method of claim 13, wherein the steering of the host vehicle comprises:
calculating the biased brake torque based on the steering angle;
transmitting a signal including information about the biased brake torque to a braking system of the host vehicle; and
steering, by the braking system, the host vehicle based on the biased brake torque.

15. The method of claim 13, wherein the controlling of the damping force comprises: determining whether the host vehicle starts turning based on the steering angle or the steering angular velocity, and determining a damping ratio of the damper.

16. The method of claim 13, wherein the controlling of the damping force comprises:
determining that the host vehicle starts turning when the steering angle is equal to or greater than a reference angle or the steering angular velocity is equal to or greater than a reference angular velocity; and increasing a damping ratio of the damper;
transmitting a signal including information about the damping ratio of the damper to a suspension system of the host vehicle; and
controlling, by the suspension system, the damping force of the damper based on the damping ratio of the damper.

17. The method of claim 16, wherein the increasing of the damping ratio comprises: increasing the damping ratio of the damper provided on a wheel, to which the biased brake torque is applied.

18. The method of claim 13, wherein the controlling of the damping force comprises:
adjusting the damping force of the damper provided on a front wheel, to which the biased brake torque is applied according to a first stage; and
adjusting the damping force of the damper provided on a rear wheel, to which the biased brake torque is applied according to a second stage;
wherein the damping force according to the first stage is larger than the damping force according to the second stage.

19. The method of claim 13, wherein the controlling of the damping force comprises: controlling the damping force of the damper according to a plurality of the first stages or a plurality of the second stages.

20. The method of claim 19, wherein the controlling of the damping force comprises:
calculating a turning angle of the host vehicle based on the steering angle or the steering angular velocity; and
determining the plurality of the first stages or the plurality of the second stages according to the turning angle of the host vehicle.
